(19) United States
(12) Patent Application Publication
(10) Pub. No.: US 2008/0135323 A1
(43) Pub. Date: Jun. 12, 2008

(54) Hydraulic control system for automatic transmission

(75) Inventor: Dalsu Park, Kyunggi-Do (KP)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/787,783

(22) Filed: Apr. 17, 2007

(30) Foreign Application Priority Data
Dec. 12, 2006 (KP) 10-2006-0126566

(51) Int. Cl. B60K 17/10

(52) U.S. Cl. 180/367; 180/370

(57) ABSTRACT

The present invention provides a hydraulic control system for an automatic transmission of a vehicle in which an oil pump of the hydraulic control system generates hydraulic pressure and a manual valve of the hydraulic control system realizes a line conversion according to a selected shift range. The control system comprises (a) a line pressure control assembly including a regulator valve and a solenoid valve for controlling the regulator valve; (b) a hydraulic pressure control assembly including: a reducing valve; first, second, third, and fourth solenoid valves; and first, second, third, and fourth pressure control valves which are independently controlled by the first, second, third, and fourth solenoid valves, respectively; and (c) a line conversion assembly including: a first fail-safe valve interposed between the first pressure control valve of the hydraulic pressure control assembly and a low-reverse brake operating in first and reverse speeds; and a second fail-safe valve interposed between the second pressure control valve of the hydraulic pressure control assembly and a second brake operating in first and second speeds.

### CROSS-REFERENCE TO RELATED APPLICATION

This application claims priority to and the benefit of Korean Patent Application No. 10-2006-0126566 filed on Dec. 12, 2006, the entire contents of which are incorporated herein by reference.

### BACKGROUND OF THE INVENTION

(a) Field of the Invention

The present invention relates to a hydraulic control system for an automatic transmission of a vehicle. More particularly, the present invention relates to a hydraulic control system for a vehicular automatic transmission in which a control pressure of a reducing valve is supplied as a source pressure to a plurality of solenoid valves included in a hydraulic control assembly and as a source pressure to a solenoid valve included in a line pressure control assembly.

(b) Description of the Related Art

An automatic transmission of a vehicle shifts speed automatically to a target shift speed on the basis of various driving conditions such as a vehicle speed and a throttle opening.

If a driver shifts a select lever into a target shifting range, a manual valve in a hydraulic control system realizes a line conversion. In this case, hydraulic pressure supplied from an oil pump is supplied to friction elements operating in respective shift-speeds according to a duty control of solenoid valves.

FIG. 2 shows a prior art hydraulic control system for an automatic transmission that realizes four forward speeds and one reverse speed.

As shown in FIG. 2, hydraulic pressure in an oil pump 202 is controlled at a predetermined level by a regulator valve 204, and then supplied to a manual valve 206.

In this case, the manual valve 206 realizes a line conversion according to a position of a select lever (not shown), and selectively supplies hydraulic pressure to first, second, third, and fourth solenoid valves S1, S2, S3, and S4.

First, second, third, and fourth pressure control valves 208, 210, 212, and 214 are controlled respectively by the first, second, third, and fourth solenoid valves S1, S2, S3, and S4. The pressure control valves supply the hydraulic pressure to friction elements via a switch valve 216 or first and second fail-safe valves 218 and 220, or supply the hydraulic pressure to friction elements directly.

In other words, the first pressure control valve 208 controlled by the first solenoid valve S1 supplies the hydraulic pressure to a low-reverse brake L-R/B operating in a first (forward) speed and a reverse speed via the switching valve 216 and the first fail-safe valve 218.

The second pressure control valve 210 controlled by the second solenoid valve S2 supplies the hydraulic pressure to a second brake 2ND/B operating in first and second speeds via the second fail-safe valve 220.

The third pressure control valve 212 controlled by the third solenoid valve S3 supplies the hydraulic pressure to an under drive clutch UD/C operating in first, second, and third speeds.

The fourth pressure control valve 214 controlled by the fourth solenoid valve S4 supplies the hydraulic pressure to an over drive clutch OD/C operating in third and fourth speeds.

A reverse clutch R/C operating in the reverse speed receives the hydraulic pressure from the regulator valve 204.

Part of the hydraulic pressure controlled by the regulator valve 204 is supplied to a toque converter TC, a torque converter control valve 222 that controls the hydraulic pressure at a predetermined level for lubrication, and a damper clutch control valve 224 that controls a damper clutch in order to increase power transmission efficiency of the torque converter TC.

The damper clutch control valve 224 is controlled by a fifth solenoid valve S5 and controls On/Off operations of the damper clutch.

With the above-described configuration, the first, second, third, and fourth solenoid valves S1, S2, S3, and S4 controlled by a transmission control unit TCU (not shown) control the first, second, third, and fourth pressure control valves 208, 210, 212, and 214 so that each of the frictional elements realizes a shift operation by receiving hydraulic pressure or exhausting hydraulic pressure.

However, the prior art hydraulic control system has drawbacks because the first, second, third, fourth, and fifth solenoid valves S1, S2, S3, S4, and S5 receive the line pressure from the regulator valve 204 and the manual valve 206 as a source pressure.

That is, in the prior art hydraulic control system, line pressure can vary considerably according to operating conditions of a vehicle. This may deteriorate shift feel since solenoid valves operate sensitively and supply operational pressure to friction elements.

Also, it is difficult to control the line pressure according to various operation conditions because the line pressure depends on complementary operation of a forward range pressure, a reverse range pressure, and an elastic member elastically supporting a valve spool.

In addition, because the line pressure is high when friction elements are operated at a high speed, a shift valve for reducing hydraulic pressure is required, which in turn increases overall production costs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a hydraulic control system for an automatic transmission of a vehicle where a control pressure of a reducing valve is supplied as a source pressure to a plurality of solenoid valves operating in a hydraulic control assembly and as a source pressure to a solenoid valve operating in a line pressure control assembly.

Particularly, the present invention provides a hydraulic control system that applies a solenoid valve for controlling line pressure so that it may maintain optimal line pressure according to driving conditions. Also, the present invention provides a hydraulic control system that may increase the scope of controllability so as to enhance fuel consumption efficiency. Further the present invention provides a hydraulic control system that does not require a shift valve.

In one aspect, the present invention provides a hydraulic control system for an automatic transmission of a vehicle in which an oil pump of the hydraulic control system generates hydraulic pressure and a manual valve of the hydraulic control system realizes a line conversion according to a selected shift range.

The control system comprises: (a) a line pressure control assembly including a regulator valve and a solenoid valve for controlling the regulator valve; (b) a hydraulic pressure control assembly including: a reducing valve; first, second, third, and fourth solenoid valves; and first, second, third, and fourth pressure control valves which are independently controlled by the first, second, third, and fourth solenoid valves, respectively; and (c) a line conversion assembly including: a first fail-safe valve interposed between the first pressure control valve of the hydraulic pressure control assembly and a low-reverse brake operating in first and reverse speeds; and a second fail-safe valve interposed between the second pressure control valve of the hydraulic pressure control assembly and a second brake operating in first and second speeds.

In a preferred embodiment, the hydraulic pressure generated in the oil pump may be controlled at a predetermined level by the line pressure control assembly and is then supplied to the manual valve and the hydraulic pressure control assembly.

In another preferred embodiment, the hydraulic pressure controlled in the hydraulic pressure control assembly may be supplied to friction elements directly or via the line conversion assembly.

In still another preferred embodiment, the solenoid valve of the line pressure control assembly receives a control pressure of the reducing valve of the hydraulic pressure control assembly as a source pressure.

In yet another preferred embodiment, the first solenoid valve of the hydraulic pressure control assembly receives a line pressure as a source pressure, and the second, third and fourth solenoid valves of the hydraulic pressure control assembly receive a control pressure of the reducing valve of the hydraulic pressure control assembly as a source pressure.

In a further preferred embodiment, the first pressure control valve of the hydraulic pressure control assembly receives a line pressure and supplies hydraulic pressure to the low-reverse brake via the first fail-safe valve.

In still further preferred embodiment, the second, third, and fourth pressure control valves of the hydraulic pressure control assembly receive hydraulic pressure from the manual valve, and supply hydraulic pressure respectively to the second brake, an under drive clutch operating in first, second, and third speeds, and an over drive clutch operating in third and fourth speeds.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present control systems will be particularly useful with a wide variety of motor vehicles.

Other aspects of the invention are discussed infra.

### BRIEF DESCRIPTION OF THE DRAWINGS

FIG. 1 is a schematic diagram of a hydraulic control system according to an exemplary embodiment of the present invention in N and P ranges.

FIG. 2 is a schematic diagram of a prior art hydraulic control system in N and P ranges.

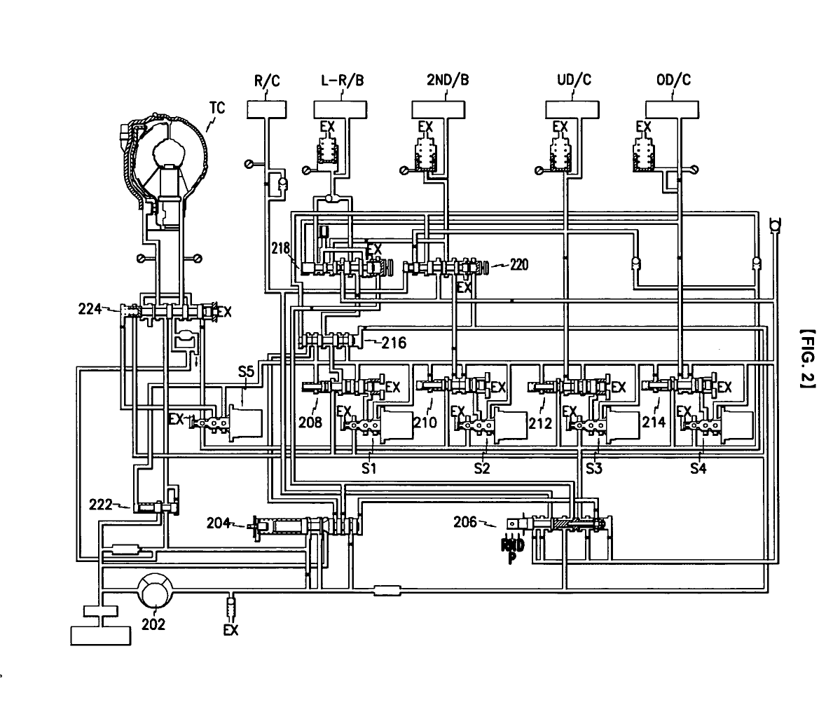

### DETAILED DESCRIPTION OF THE PREFERRED EMBODIMENTS

Reference will now be made in detail to the preferred embodiments of the present invention with reference to the accompanying drawing.

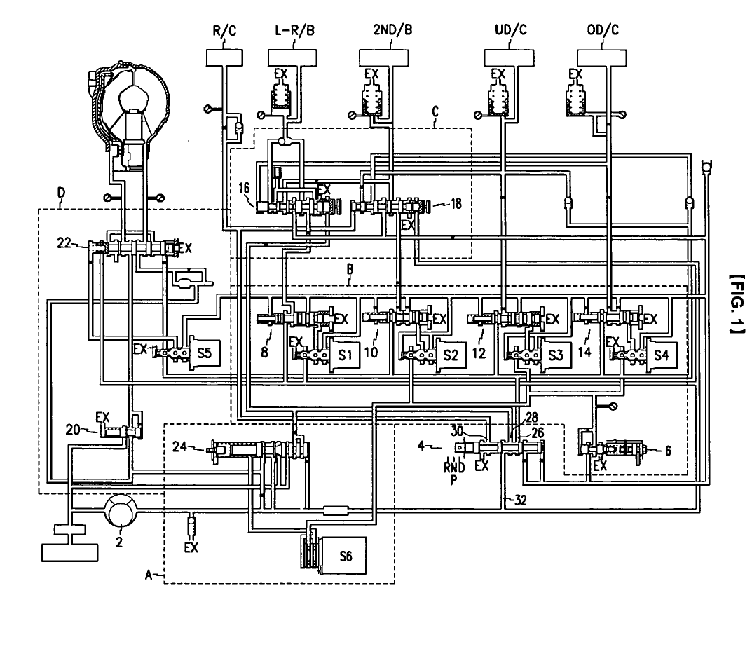

FIG. 1 is a schematic diagram of a hydraulic control system according to an exemplary embodiment of the present invention in N and P ranges.

As shown in FIG. 1, hydraulic pressure generated in an oil pump 2 is controlled at a predetermined level in a line pressure control assembly A, and supplied to a manual valve 4 and a hydraulic pressure control assembly B.

The manual valve 4 realizes a line conversion according to a position of a select lever and the hydraulic pressure controlled in the hydraulic pressure control assembly B is supplied to friction elements directly or via a line conversion assembly C.

The line pressure control assembly A includes a regulator valve 24 for controlling hydraulic pressure at a predetermined level, and a solenoid valve S6 for controlling the regulator valve 24.

The hydraulic pressure control assembly B includes a reducing valve 6, first, second, third, and fourth solenoid valves S1, S2, S3, and S4. The assembly B also includes first, second, third, and fourth pressure control valves 8, 10, 12, and 14 which are independently controlled by the first, second, third, and fourth solenoid valves S1, S2, S3, and S4, respectively.

The line conversion assembly C includes a first fail-safe valve 16 interposed between the first pressure control valve 8 and a low-reverse brake L-R/B operating in first (forward) and reverse speeds, and a second fail-safe valve 18 interposed between the second pressure control valve 10 and a second brake 2ND/B operating in first and second speeds.

A damper clutch control assembly D includes a torque converter control valve 20, a damper clutch control valve 22, and a fifth solenoid valve S5.

Part of the hydraulic pressure controlled by the regulator valve 24 is supplied to the damper clutch control assembly D.

The sixth solenoid valve S6 controlled by a transmission control unit TCU (not shown) controls the regulator valve 24 according to a driving condition, so that the line pressure may be controlled according to a driving condition.

The sixth solenoid valve S6 controls the regulator valve 24 by receiving control pressure of the reducing valve 6 as a source pressure.

The manual valve 4 is supplied with a line pressure from a line pressure line 32 and selectively supplies hydraulic pressure to a D range pressure line 26, an N range pressure line 28, and an R range pressure line 30 according to a shift range.

The D range pressure line 26 is connected to the second, third, and fourth pressure control valves 10, 12, and 14, and the N range pressure line 28 is connected to the regulator valve 24 and the first fail-safe valve 16.

The R range pressure line 30 is connected to a reverse clutch R/C operating in first and reverse speeds, and connected to the second fail-safe valve 18 to supply a control pressure.

The reducing valve 6 of the hydraulic pressure control assembly B controls the line pressure at a relatively low and stable pressure, and the control pressure of the reducing valve 6 is supplied as a source pressure to the second, third, fourth, and sixth solenoid valves S2, S3, S4, and S6.

The first solenoid valve S1 receives a line pressure directly as a source pressure, and the first pressure control valve 8 controlled by the first solenoid valve S1 supplies a control pressure to the low-reverse brake L-R/B operating in first and reverse speeds via the first fail-safe valve 16.

The second solenoid valve S2 receives a control pressure of the reducing valve 6 as a source pressure and controls the second pressure control valve 10, and the second pressure control valve 10 supplies a control pressure to the second brake 2ND/B operating in first and second speeds via the second fail-safe valve 18.

The third solenoid valve S3 receives a control pressure of the reducing valve 6 as a source pressure and controls the third pressure control valve 12, and the third pressure control valve 12 supplies a control pressure to an under drive clutch operating in first, second, and third speeds.

The fourth solenoid valve S4 receives a control pressure of the reducing valve 6 as a source pressure and controls the fourth pressure control valve 14, and the fourth pressure control valve 14 supplies a control pressure to an over drive clutch OD/C operating in third and fourth speeds.

The torque converter control valve 20 in the damper clutch control assembly D controls hydraulic pressure supplied from the regulator valve 24 at a predetermined level, and supplies the hydraulic pressure to the torque converter TC and for lubrication.

The damper clutch control valve 22 controlled by the fifth solenoid valve S5 controls On/Off operations of the damper clutch for enhancement of power delivery efficiency.

In the control system according to the exemplary embodiment of the present invention, similar to the prior art, the low-reverse brake L-R/B and the under drive clutch UD/C operate in a first speed, and the under drive clutch UD/C and the second brake 2ND/B operate in a second speed.

Also, the under drive clutch UD/C and the over drive clutch OD/C operate in a third speed, and the over drive clutch OD/C and the second brake 2ND/B operate in a fourth speed. Further, the low-reverse brake L-R/B and the reverse clutch R/C operate in a reverse speed.

As the basic operation that supplies hydraulic pressure to friction elements operating in each shift range is similar to a conventional hydraulic control system, a detailed description thereof will be omitted.

As described above, the hydraulic control system according to the preferred embodiment of the present invention supplies a stable reducing pressure of the reducing valve 6 to the second, third, and fourth solenoid valves S2, S3, and S4, and makes the regulator valve 24 be controlled by the sixth solenoid valve S6 to control the line pressure.

Therefore, the second, third, and fourth pressure control valves 10, 12, and 14, which are respectively controlled by the second, third, and fourth solenoid valves S2, S3, and S4, stably operate so that the second brake 2ND/B, the under drive clutch UD/C, and the over drive clutch OD/C can stably operate, thereby enhancing shift feel.

In addition, line pressure may be controlled according to various driving conditions of a vehicle.

As described above, because the control pressure supplied from the reducing valve is supplied as a source pressure to a plurality of solenoid valves operating in the hydraulic control assembly, the hydraulic control system according to an exemplary embodiment of the present invention provides a more stable shift feel compared to a conventional hydraulic control system that involves a considerably fluctuating line pressure used as a control pressure.

The hydraulic control system according to an exemplary embodiment of the present invention applies a solenoid valve for controlling the line pressure so that it may maintain optimal line pressure according to a driving condition. The system also may increase the scope of controllability so as to enhance overall fuel consumption efficiency.

Further, since the system may not require a shift valve, which controls hydraulic pressure supplied to friction elements operating in a high speed range, manufacturing costs can be reduced.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. A hydraulic control system for an automatic transmission of a vehicle in which an oil pump of the hydraulic control system generates hydraulic pressure and a manual valve of the hydraulic control system realizes a line conversion according to a selected shift range, the control system comprising:
(a) a line pressure control assembly including a regulator valve and a solenoid valve for controlling the regulator valve;
(b) a hydraulic pressure control assembly including: a reducing valve; first, second, third, and fourth solenoid valves; and first, second, third, and fourth pressure control valves which are independently controlled by the first, second, third, and fourth solenoid valves, respectively; and
(c) a line conversion assembly including: a first fail-safe valve interposed between the first pressure control valve of the hydraulic pressure control assembly and a low-reverse brake operating in first and reverse speeds;
and a second fail-safe valve interposed between the second pressure control valve of the hydraulic pressure control assembly and a second brake operating in first and second speeds.

2. The hydraulic control system of claim 1, the hydraulic pressure generated in the oil pump is controlled at a predetermined level by the line pressure control assembly and is then supplied to the manual valve and the hydraulic pressure control assembly.

3. The hydraulic control system of claim 2, the hydraulic pressure controlled in the hydraulic pressure control assembly is supplied to friction elements directly or via the line conversion assembly.

4. The hydraulic control system of claim 1, wherein the solenoid valve of the line pressure control assembly receives a control pressure of the reducing valve of the hydraulic pressure control assembly as a source pressure.

5. The hydraulic control system of claim 1, wherein the first solenoid valve of the hydraulic pressure control assembly receives a line pressure as a source pressure, and the second, third and fourth solenoid valves of the hydraulic pressure control assembly receive a control pressure of the reducing valve of the hydraulic pressure control assembly as a source pressure.

6. The hydraulic control system of claim 1, wherein the first pressure control valve of the hydraulic pressure control assembly receives a line pressure and supplies hydraulic pressure to the low-reverse brake via the first fail-safe valve.

7. The hydraulic control system of claim 1, wherein the second, third, and fourth pressure control valves of the hydraulic pressure control assembly receive hydraulic pressure from the manual valve, and supply hydraulic pressure respectively to the second brake, an under drive clutch operating in first, second, and third speeds, and an over drive clutch operating in third and fourth speeds.
